(19) United States
(12) Patent Application Publication
(10) Pub. No.: US 2010/0252961 A1
(43) Pub. Date: Oct. 7, 2010

(54) OPTICAL FILM REPLICATION ON LOW THERMAL DIFFUSIVITY TOOLING WITH CONFORMAL COATING

(75) Inventors: Randy S. Bay, Woodbury, MN (US); Graham M. Clarke, Woodbury, MN (US); Thomas R. J. Corrigan, Saint Paul, MN (US); Raymond P. Johnston, Lake Elmo, MN (US); Brain W. Lueck, Houlton, WI (US); Robert B. Secor, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/418,660

(22) Filed: Apr. 6, 2009

(51) Int. Cl. B29C 43/24; B29C 59/16

(52) U.S. Cl. 264/448; 264/175; 425/370

(57) ABSTRACT

A system and method for extrusion replication of microstructures to make microreplicated optical films. The system includes press roll and a replicating member. The replicating member includes a low thermal diffusivity material having a microreplicated outer surface or an organic material having a microreplicated outer surface. An inorganic conformal coating is disposed over the patterned outer surface of the organic or low thermal diffusivity material.

### BACKGROUND

Extrusion replication is a commonly used process in which resin is melted in an extruder, formed into a molten film in a die, and then cast or pressed between two rolls to form a film. While one roll typically has a smooth surface, the second roll frequently has a patterned surface. The high nip load between the two rolls forces the melted resin into the concave areas on the roll with the patterned surface. The resulting film bears a negative of the image on the surface of the patterned roll. Microreplicated patterns on films have varying levels of precision dependent on a number of factors used during the extrusion process. Such critical variables include the temperatures of the melted resin and the two rolls, the nip force between the rolls, and material characteristics of both the rolls and melted resin, including the viscosity of the resin.

One particular challenge in high fidelity microreplication is achieving a high level of fill of the concave areas in the patterned surface of a replicating roll. A need exists for additional extrusion replication methods that improve fidelity of the microreplicated pattern.

### SUMMARY

A method consistent with the present disclosure can create a microreplicated surface on an extruded film. The method for extrusion replication comprises heating a resin material to form a flowable melt material and discharging the flowable melt material into an area of contact between a press roll and a replicating member. The replicating member includes a low thermal diffusivity material with a microreplicated patterned outer surface and an inorganic conformal coating disposed over the patterned outer surface of the organic material. The method finally includes forming from the melt material a film having a replicated pattern corresponding with the microreplicated patterned outer surface of the replicating member.

In another aspect, the present disclosure includes a first system for extrusion replication. The first system includes a press roll and a replicating member. The replicating member is located adjacent the press roll and is capable of extruding and replicating a material between the press roll and the replicating member. The replicating member includes a low thermal diffusivity material with a microreplicated patterned outer surface and an inorganic conformal coating disposed over the patterned outer surface of the organic material.

In a third aspect, the present disclosure includes a replicating member for use in an extrusion replication system. The replicating member includes a cylindrical roll core, a layer of low thermal diffusivity material having a microreplicated patterned outer surface disposed on the cylindrical roll core. A layer of conformal inorganic material is disposed over the patterned outer surface of the organic material.

In yet another aspect, the present disclosure includes a second system for extrusion replication. The second system includes a press roll and a replicating member. The replicating member is located adjacent the press roll and is capable of extruding and replicating a material between the press roll and the replicating member. The replicating member includes an organic material with a microreplicated patterned outer surface and an inorganic conformal coating disposed over the patterned outer surface of the low thermal diffusivity material.

### BRIEF DESCRIPTION OF THE DRAWINGS

The invention may be more completely understood in consideration of the following detailed description of various embodiments of the invention in connection with the accompanying drawings, in which:

FIG. 1 shows a schematic diagram of an exemplary system for extrusion replication.

FIG. 2 shows a cross section of an exemplary replicating member.

FIG. 3 shows a cross section of an exemplary lens pattern on the outer surface of a replicating member.

FIG. 4 shows a perspective view of an exemplary prism pattern on the outer surface of a replicating member.

FIG. 5 shows a top view of an image of a film with an exemplary curve-sided cone pattern microreplicated on its surface.

The figures are not necessarily to scale.

### DETAILED DESCRIPTION

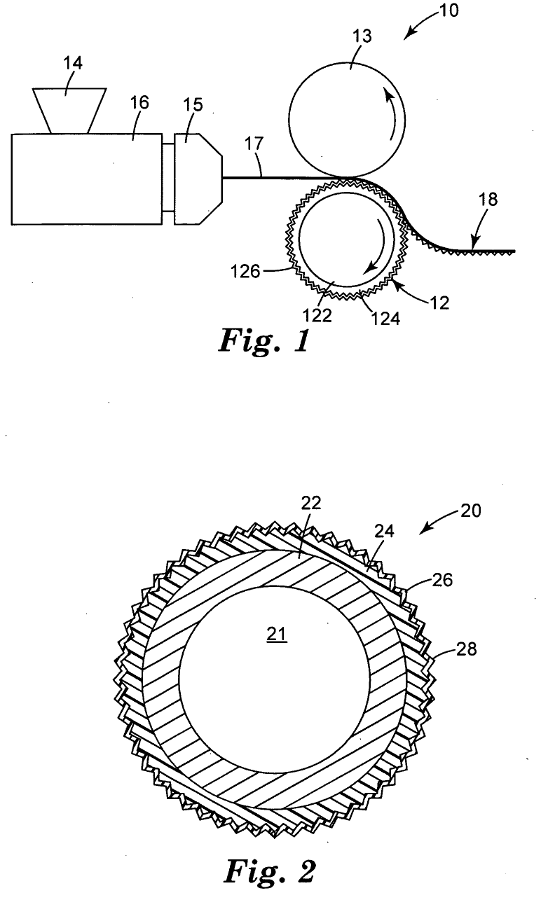

FIG. 1 shows a system for extrusion replication 10. In the extrusion replication process using system 10, resin materials 14 are heated to a flowable melt. The melted resin material 14 can then be passed by an extruder 16 through a die 15 to produce a continuous resin sheet material or film 17. The continuous film 17 can be subjected to the nip load between a replicating member 12 and a press roll 13, which sandwich the continuous film. Upon release from the replicating member, the resulting patterned film 18 contains a negative image of the replicating member's surface pattern.

Resin material 14 can be heated to a flowable melt. The following are examples of resin material 14: thermoplastic polymers such as polyethylene, polypropylene, polystyrenes, polymethylmethacrylate, polyamide, polyester, polycarbonate, polymethyleneoxide, polybutyleneterephthalate as well as copolymers such as styrene acrylonitrile copolymers, styrene (meth)acrylate copolymers, styrene maleic anhydride copolymers, nucleated semi-crystalline polyesters, copolymers of polyethylenenaphthalate, polyimide copolymers, polyetherimide, polyethylene oxides and copolymers of acrylonitrile, butadiene, and styrene and blends of these materials with each other as well as other resins. The resin may contain additives such as, but not limited to, a light diffusion agent, a UV absorber, a thermal stabilizer, filler, or an antistatic agent. The resin melt may be at a temperature of approximately 250° Celsius or from about 200° to about 300° Celsius during the extrusion process. The final patterned film 18 can have any appropriate thickness, for example, 125 microns or about 25 microns to about 500 microns. The final patterned film 18 can have any appropriate width. For example, it may have a width of about 10 centimeters to about 2 meters.

The extruder 16 may be a single screw or a twin screw extruder. A single type of resin 14 can be extruded through the die 15, or alternatively, two or more types of resin 14 can be coextruded into a single laminate structure. A die and process for producing co-extruded polymeric materials are described in detail in U.S. Pat. No. 6,767,492, incorporated herein by reference as if fully set forth. The extruded film 17 can then pass between the press roll 13 and the replicating member 12.

The press roll 13 can be made of metal, e.g. steel such as stainless steel, or any other appropriate material. The press roll 13 can have a diameter of about 30 cm, or, for example from about 20 cm to about 60 cm or more or less. The press roll 13 may have a plated surface formed with, e.g., chromium, copper, nickel, nickel-phosphorous plating, or any other serviceable plating. The press roll 13 can have a mirror finish, or can have a structured surface, if desirable.

The replicating member 12 can transfer its patterned surface profile to the film 18 so that the film 18 possesses a surface profile complementary to that of the replicating member 12. Replicating member 12 can have an inner metal core 122, e.g., steel or any other appropriate material. It can be surrounded by a layer 124 of an organic or low thermal diffusivity material. A pattern can be transferred into the organic or low thermal diffusivity material 124 by a variety of methods. A conformal coating 126 can be made of nickel, copper or chrome or any other appropriate material and can be deposited over the organic and low thermal diffusivity layer 124, conforming to the surface pattern of the layer 124. A conformal coating 126 consistent with the present disclosure has both exterior and interior surfaces that conform to the pattern of the underlying layer 124.

FIG. 2 shows a cross section of an exemplary replicating member 20. The replicating member 20 can have a metal core 22 made of metal such as steel or aluminum. A metal core 22 can have a diameter of about 30 cm, or, for example from about 20 to about 60 cm or more or less. The thickness of the walls of the metal core 22 can be determined by the resistance to bending required, but frequently ranges from about 10 mm and about 100 mm. A metal core 22 can have water flowing through the center 21 with a temperature of about 5° Celsius to about 270° Celsius, or more preferably about 10° Celsius to about 200° Celsius, for example, 90° Celsius, during the extrusion process. The temperature of the metal core 22 can be significantly less than that of the melted resin, and temperature can be maintained by any appropriate method.

A low thermal diffusivity or organic layer 24 can cover the surface of the metal core 22. The thermal diffusivity (alpha) of a given material is defined by the ratio of its conductivity (k) to its density (rho) times its specific heat capacity (cₚ). This ratio is seen in the equation below:

$$α = \frac{k}{ρ \times {c}_{p}}$$

A low thermal diffusivity material may have an alpha of, for example, less than 5×10⁻⁵ m²/sec, or more preferably less than 5×10⁻⁶ m²/sec, or most preferably less than 5×10⁻⁷ m²/sec. A low thermal diffusivity material can also have low thermal conductivity.

Examples of organic materials include polymers, for example, polycarbonate, polystyrene, polyurethane, polysulfone, polyimide, polyamide, polyester, polyether, phenolic, epoxy, acrylics, methacrylics, or combinations thereof. Alternatively, this layer 24 could be made of a low thermal diffusivity material such as a ceramic. Organic or low thermal diffusivity layer 24 can have any appropriate thickness, for example, about 20 microns to about 250 microns. A pattern can be transferred to the surface of layer 24 by a variety of means. For example, the surface could be laser ablated by use of an excimer laser along with an optical system that forms an image to be machined onto the surface of layer 24. Laser ablation can be achieved by a variety of appropriate methods. For example, when laser ablating a pattern, less than the required dose of light can be applied to each image position on the surface before moving on to the next image position. The process would then be repeated until each image position has received the appropriate amount of light and the pattern is fully ablated. Such a method is described more fully in U.S. Pat. No. 6,285,001, incorporated herein by reference as if fully set forth. Alternatively, a pattern can be created by diamond turning, etching, cutting, scoring, engraving, printing, lithography, molding and the like. For example, diamond turning can be used to form continuous patterns in the surface of layer 24. In one specific embodiment, the structures can be machined by a technique known as thread cutting, in which a continuous cut is made on surface 24 while the diamond tool is moved in a direction transverse to the turning of the roll. A typical diamond turning machine can provide independent control of the depth that the tool penetrates into the roll, the horizontal and vertical angles that the tool makes to the roll, and the transverse velocity of the roll. Such a process is described in greater detail in PCT Published Application No. 00/48037.

Exemplary microreplicated patterns include curve-sided cones, lenses, prisms, cylinders, posts, needles, microfluidic flow channels, airbleed channels, anti-reflective structures, pocket structures and any other appropriate microstructured pattern.

An inorganic conformal coating 26 can be applied to the outer surface of the organic or low thermal diffusivity layer 24 so that the low diffusivity layer is at least partially covered by the conformal coating 26. Layer 24 can serve as an insulator between the core 22 of the replicating member 20 and the conformal coating 26. This insulation, along with exposure to the heated continuous film, allows the conformal coating temperature to achieve a higher temperature than that of the core 22 during the microreplication process. The degree of fill in the patterned surface of the replicating member is largely dependent on the liquid viscosity of the melted resin and the force of the nip load between the replicating member 20 and the press roll. The higher temperature of the conformal coating 26 achieved by inclusion of the low diffusivity layer 24 can result in decreased film viscosity. This facilitates an increase in degree of fill or allows a reduced nip load to achieve the same replication precision. In addition to increased replication precision, a system for extrusion replication consistent with the present disclosure can have higher processing speeds because the core 22 can be maintained at a lower temperature. A system for extrusion replication can also be used to replicate and laminate simultaneously with high temperature resins. Additionally, such a system can be used to make dimensionally stable tooling for other processes from a single resin in a single step.

The conformal coating 26 can be made from a variety of materials. Examples include nickel, copper, chrome, or any other appropriate material. A conformal coating 26 can have a substantially uniform thickness of about 0.5 microns to about 200 microns. The thin nature of the coating 26 allows its surface to increase in temperature during the microreplication process. A conformal coating 26 can provide several advantages. For example, conformal coating 26 may increase the durability of the outer surface of replicating member 20. Increased durability can include, for example, increased resistance to scratching and increased durability when cleaned with a solvent or by other methods.

Conformal coating 26 can be deposited by a variety of processes including metal vapor coating, sputtering, and chemical vapor deposition, plasma deposition or a plasma process. An electrochemical process can be used after a seed metallic layer for the conformal coating is applied. Electro-less processes are generally preferable because they can result in a more uniform thickness for conformal coating 26.

Conformal coating 26 can optionally be covered by a release coating, such as a surface tension lowering chemical, on surface 28. Release coating can help obtain a clean release of the patterned film from the surface of replicating member 20. Release coating can be optionally applied to the surface of conformal coating 26, for example, as a vapor or as a solution. Examples of materials that could be used as a release coating include, but are not limited to, silicones and fluorochemicals, e.g., fluorinated benzotriazoles, (as described in U.S. Pat. No. 6,376,065, incorporated herein by reference as if fully set forth) fluorocarbons, fluorochemical trichlorosilanes, and fluorochemical monophosphates (as described in U.S. Pat. Publ. No. 20040043146, incorporated herein by reference as if fully set forth). Typically, the release coating 28 is applied in sufficient quantity to achieve at least monolayer coverage of the surface of conformal coating 26.

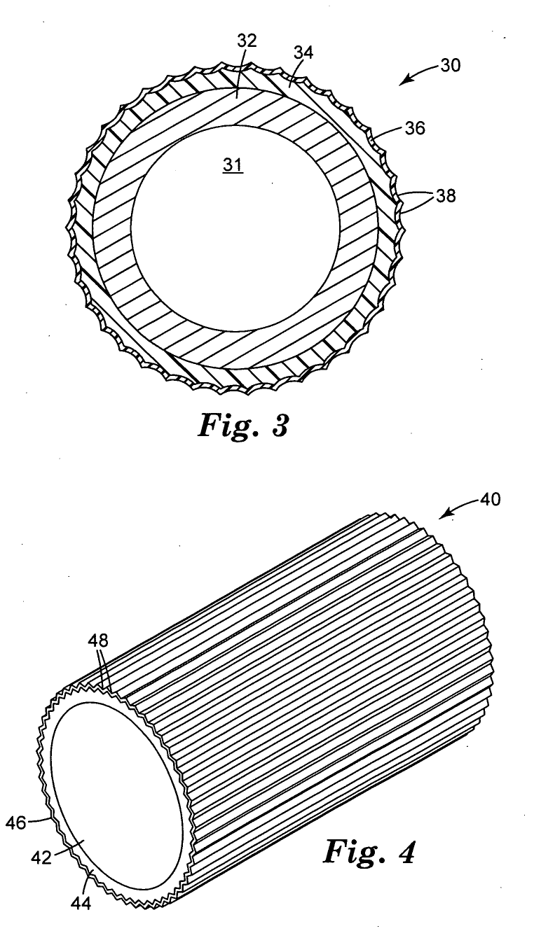

FIGS. 3 and 4 show a cross section and a perspective view, respectively, of exemplary replicating members having different surface patterns. A pattern consistent with the present disclosure can be regular, random, or pseudo-random. For example, a regular pattern may contain curve-sided cones, lenses, prisms, cylinders, posts, needles, etc. An exemplary random pattern can have irregularly spaced peaks with having a particular mean height and within a given height range. Additionally, the surface structure of the replicating member includes a three dimensional pattern so that when the pattern is transferred onto a film, the film changes structurally. While the patterns shown in FIGS. 3 and 4 extend along the length of the replicating member, regular patterns consistent with the present disclosure can extend in any appropriate direction, for example, around the circumference of the replicating member. The patterns can also be discontinuous as in the cases of curve-sided cones or posts.

FIG. 3 shows an exemplary replicating member 30 with a metal core 32 and organic or low thermal diffusivity layer 34. A lens 38 pattern repeats around the circumference and extends along the length of the surface of the organic or low thermal diffusivity layer 34. Each structure in a lens pattern may have a depth or height of about 1 micron to about 250 microns. The pitch of each structure can be about 5 microns to about 500 microns or more or less. Inorganic conformal coating 36 covers the surface of the organic or low diffusivity layer 34. Conformal coating 36 can have a thickness of about 0.5 microns to about 200 microns or more or less, and corresponds to the lens shapes of layer 34.

FIG. 4 shows a replicating member 40 with a metal core 42 and organic or low diffusivity layer 44. A prism 48 pattern repeats around the circumference and extends along the length of the surface of the organic or low thermal diffusivity layer 44. Each structure in a prism pattern may have a depth or height of about 1 micron to about 250 microns. The pitch of each structure can be about 5 microns to about 500 microns or more or less. Conformal coating 46 can have a thickness of about 0.5 microns to about 200 microns or more or less, and corresponds to the lens shapes of layer 44.

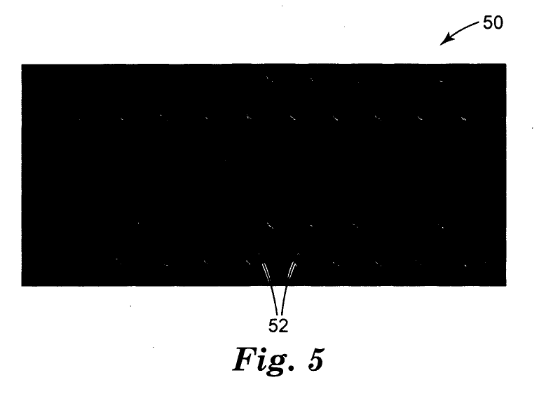

FIG. 5 shows a top view of an image of film 50 with an exemplary curve-sided cone pattern microreplicated on its surface. Concave curve-sided cone shapes 52 were formed by a replicating member with corresponding convex curve-sided cone shapes. The curve-sided cones shown have a width and pitch of about 10 microns and a depth of about 7 microns. Curve-sided cone shapes 52 can have a depth or height of approximately 1 micron to about 250 microns or more or less. Curve-sided cone shapes 52 may generally have a pitch or width of about 5 microns to about 500 microns or more or less. Film 50 can be made of any appropriate material, as discussed above. In this instance, film 50 has a thickness of about 125 microns, but can have any appropriate thickness, for example, about 25 microns to about 500 microns, in an embodiment consistent with the present disclosure.

While the present invention has been described in connection with exemplary embodiments, it will be understood that many modifications will be readily apparent to those skilled in the art, and this application is intended to cover any adaptations or variations thereof. For example, various types of patterns may be replicated on a variety of films without departing from the scope of the invention. This invention should be limited only by the claims and equivalents thereof.

### EXAMPLES

### COMPARATIVE EXAMPLE

A replicating member was formed on the surface of a steel core roll coated with copper. A linear prismatic pattern with a 90 degree included angle and a 50 micron pitch was cut circumferentially into the outer surface of the member using a diamond turning technique. The roll was then plated with chrome. The temperature of the replicating member was maintained at a temperature of about 77° Celsius. A three layer co-extruded film including skin layers of SAN Tyril™125, available from Dow Corporation, and a core layer including Polycarbonate Makrolon™2407, available from Bayer AG, was extruded through a die at a temperature of 260° Celsius to form a continuous film. The continuous resin film was subjected to a nip load of 42,000 N/m between the replicating member and the press member at a line speed of about 15 m/min. The resulting microstructured film had a fill of about 84%, calculated by comparing the dimensions of the microstructured features on the film to the inverse features on the surface of the replicating member.

### EXAMPLE

A replicating member was formed by attaching a structured surface to the outside of a steel roll. A linear prismatic film comprising a structure consisting of linear prisms with an included angle of 90 degrees and a pitch of 50 microns formed from a UV cured acrylate resin cast onto PET film. This prismatic film was vapor coated with a 10 nm thick chrome layer. This film construction was then laminated with 50 microns thick acrylic based pressure sensitive adhesive film to the non-structured side. The structured surface of the replicating member was coated with a monolayer mold release agent. This film construction was then laminated to a 250 micron thick steel shim. The shim was secured magnetically to the steel roll via magnets embedded in the outer shell of the roll. During the replication process, the inner tool temperature of the replicating member was maintained at a temperature of about 77° Celsius. A three layer co-extruded film including skin layers of SAN Tyril™ 125, available from Dow Corporation, and a core layer including Polycarbonate Makrolon™ 2407, available from Bayer AG, was extruded through a die at a temperature of 260 C to form a continuous film. Prior to the die, the SAN melt was at a temperature of 215° Celsius and the polycarbonate melt was at a temperature of 260° Celsius. The continuous resin film was subjected to a nip load of 42,000 N/m between the replicating member and the press member at a line speed of about 15 m/min. The resulting microstructured film had a fill of about 95%, demonstrating higher precision replication than the metal only tooling in the Comparative Example.

What is claimed is:

1. A method for extrusion replication, comprising steps of:
heating a resin material to form a flowable melt material; and
discharging the flowable melt material into an area of contact between a press roll and a replicating member;
wherein the replicating member comprises:
a low thermal diffusivity material having a microreplicated patterned outer surface; and
an inorganic conformal coating disposed over the patterned outer surface of the organic material; and
forming from the melt material a film having a microreplicated pattern corresponding with the microreplicated patterned outer surface of the replicating member.

2. The method of claim 1, wherein the low thermal diffusivity material comprises an organic material.

3. The method of claim 2 wherein the organic material comprises at least one of:
polycarbonate, polystyrene, polyurethane, polysulfone, polyimide, polyamide, polyester, polyether, phenolic, epoxy, methacrylics, or any combinations thereof.

4. The method of claim 1 wherein the conformal coating comprises at least one of: nickel, chrome and copper.

5. The method of claim 1, wherein the microreplicated patterned outer surface is formed by at least one of: a laser ablation process, a diamond turning process and a molding process.

6. The method of claim 1, wherein the inorganic conformal coating is disposed over the patterned outer surface of the low thermal diffusivity material using a plasma deposition process.

7. The method of claim 1, wherein the inorganic conformal coating is disposed over the patterned outer surface of the low thermal diffusivity material using a solvent application process.

8. A system for extrusion replication, comprising:
a press roll; and
a replicating member located adjacent the press roll and capable of extruding and replicating a material between the press roll and the replicating member,
wherein the replicating member comprises:
a low thermal diffusivity material having a microreplicated patterned outer surface; and
an inorganic conformal coating disposed over the patterned outer surface of the organic material.

9. The system of claim 8, wherein the low thermal diffusivity material comprises an organic material.

10. The system of claim 9, wherein the organic material comprises at least one of:
polycarbonate, polystyrene, polyurethane, polysulfone, polyimide, polyamide, polyester, polyether, phenolic, epoxy, methacrylics, or any combinations thereof.

11. The system of claim 8, wherein the conformal coating comprises at least one of: nickel, chrome and copper.

12. The system of claim 8, wherein the low thermal diffusivity material comprises a ceramic material.

13. The system of claim 8, wherein the microreplicated patterned outer surface includes a pattern comprising at least one of: a prism, a lens, a curve sided cone, a cylinder, a post and a needle.

14. The system of claim 8, wherein the microreplicated patterned outer surface includes a regular, random, or pseudo-random pattern.

15. A replicating member for use in an extrusion replication system, comprising:
a cylindrical core roll;
a layer of low thermal diffusivity material having a microreplicated patterned outer surface disposed on the cylindrical roll core; and
a layer of conformal inorganic material disposed over the patterned outer surface of the organic material.

16. The replicating member of claim 15, wherein the microreplicated patterned outer surface includes a pattern comprising at least one of: a prism, a lens, a curve sided cone, a cylinder, a post and a needle.

17. The replicating member of claim 15, wherein the microreplicated patterned outer surface includes a regular, random, or pseudo-random pattern.

18. The system of claim 15, wherein the low thermal diffusivity material comprises an organic material.

19. The replicating member of claim 18 wherein the organic material comprises at least one of:
polycarbonate, polystyrene, polyurethane, polysulfone, polyimide, polyamide, polyester, polyether, phenolic, epoxy, methacrylics, or any combinations thereof.

20. A system for extrusion replication, comprising:
a press roll; and
a replicating member located adjacent the press roll and capable of extruding and replicating a material between the press roll and the replicating member,
wherein the replicating member comprises:
an inorganic material having a microreplicated patterned outer surface; and
an inorganic conformal coating disposed over the patterned outer surface of the low thermal diffusivity material.

21. The system of claim 20, wherein the microreplicated patterned outer surface includes a pattern comprising at least one of: a prism, a lens, a curve sided cone, a cylinder, a post and a needle.

22. The system of claim 20, wherein the microreplicated patterned outer surface includes a regular, random, or pseudo-random pattern.

23. The system of claim 20, wherein the conformal coating comprises at least one of: nickel, chrome and copper.
